(19) United States
(12) Patent Application Publication
(10) Pub. No.: US 2013/0011014 A1
(43) Pub. Date: Jan. 10, 2013

(54) SURVEILLANCE SYSTEM AND METHOD

(76) Inventors: Jesse Sheng Jin, St Ives (AU); Sze Lok Au, Changzhou city (CN)

(21) Appl. No.: 13/583,922

(22) PCT Filed: Mar. 9, 2010
(86) PCT No.: PCT/CN2010/070941

§ 371 Date: Sep. 10, 2012

(51) Int. Cl. G06K 9/78

(52) U.S. Cl. 382/103

(57) ABSTRACT

A method of performing a surveillance of a plurality of surveillance zones operable using a computerised system communicably interfaced with a plurality of input devices, each of the plurality of surveillance zones being monitored by at least one of the plurality of input devices, the method including the steps of: (i) the computerised system receiving input data captured by each of the plurality of input devices, the received input data representing characteristics of the surveillance zones under surveillance by the respective input devices; (ii) the computerised system comparing at least one characteristic of each surveillance zone against at least one surveillance ranking parameter; (iii) the computerised system assigning priority rating values to the results of each comparison between the at least one characteristic and the at least one surveillance ranking parameter.

### TECHNICAL FIELD

The present invention relates to the field of surveillance systems and in particular surveillance systems utilising multiple surveillance devices to simultaneously monitor multiple surveillance zones for occurrence of potential security threats or other events of interest.

### BACKGROUND OF THE INVENTION

Surveillance camera systems employ multiple cameras to simultaneously monitor potential security threats arising in different locations. In some conventional systems, multiple still image or video streams captured by the cameras are presented to a human operator (such as a security guard) for centralised review on a single display screen. The multiple camera feeds may either be presented to the human operator in short-interval rotation upon the single display screen, or, be tiled across the display screen. The human operator is responsible for manually reviewing the multiple incoming camera feeds in seeking to identify potential threats which may warrant increased surveillance or initiation of an appropriate emergency response.

Unfortunately existing systems such as described above tend to exhibit several problems. Firstly, it is often impracticable and ineffective for a human operator to thoroughly review each of the multiple camera feeds simultaneously in real-time and potential security threats captured by certain cameras may be missed due to human error. Whilst additional manpower may be employed to assist in reviewing the multiple camera feeds, this incurs additional labour costs. Furthermore, as the number of locations being simultaneously monitored increases, the cost of purchasing additional surveillance equipment and the space to house additional display monitors becomes a burden.

One proposed solution to the above problems has been to divide the multiple surveillance cameras into categories of “high priority” and “low priority” based on predetermined assumptions as to the importance a particular location being monitored, and/or, the probability of a security threat arising in each location. A human operator may then focus attention upon the “high priority” camera feeds whilst the “low priority” camera feeds are typically archived for later review. In some cases, feeds from “low priority” cameras may be entirely discarded without any archiving being performed at all.

By focusing attention primarily upon “high priority” camera feeds, fewer human operators may be required to perform a manual review of the camera feeds thereby reducing labour and surveillance equipment costs. However, this approach is still problematic in that the determination of “high priority” and “low priority” camera feeds is merely based on assumptions as to which cameras are more likely to capture a security threat rather than an actual identification of potential security threats captured by multiple cameras in real-time. Accordingly, there is a risk that actual security threats captured by “low priority” cameras may be overlooked due to the lack of attention paid to such cameras. Moreover, even with a more select and manageable number of “high priority” camera feeds being reviewed by a human operator, security threats captured by “high priority” cameras may still be missed due to human error.

### SUMMARY OF THE INVENTION

The present invention seeks to alleviate at least one of the problems described above in relation to the prior art.

The present invention may involve several broad forms. Embodiments of the present invention may include one or any combination of the different broad forms herein described.

In a first broad form, the present invention provides a method of performing a surveillance of at least a first and a second surveillance zone, the method being operable using a computerised system and including the steps of:
(i) receiving first and second input datas representing characteristics of the first and second surveillance zones respectively;
(ii) comparing the characteristics of the first and second surveillance zones against at least one surveillance ranking parameter; and
(iii) ranking the first and second surveillance zones in order of priority for surveillance by reference to results of the comparisons of the characteristics with the at least one surveillance ranking parameter.

Preferably, the first and second input datas may be captured by separate input devices. Typically, the input devices include at least one of a still image camera, a video camera, an infra-red sensor, a radiation detector, a temperature sensor, an air-quality sensor, a smoke sensor and a sound sensor. It would be understood by a person skilled in the art that other input devices may be utilised in embodiments of the present invention or in combinations thereof to assist in suitably identifying security threats or other events of interests during surveillance.

Typically, if the first and/or second input datas includes image or video data captured by a camera, characteristics of the first and/or second surveillance zone represented by the image or video data are identified and/or measured by applying a image or video analysis algorithm. Typically, the image or video analysis algorithm may be implemented as software for running on a computing device, or, as hardware in the form of a digital signal processor, a field-programmable gate array or an integrated circuit.

Typically, the first and/or second surveillance zones may include at least one of a two-dimensional space, a three-dimensional space, a person, an animal and an object. An object may include for instance a vehicle, a package, a suitcase and the like which may in certain circumstances be considered of particular interest during a surveillance for potential security threats.

Preferably, where the surveillance zone includes a three-dimensional space, the at least one surveillance ranking parameter may include at least one of:

(a) a threshold number of persons, animals and/or objects identified or measured in the first and/or second surveillance zone;
(b) a threshold position of a person, animal, and/or object within the first and/or second surveillance zone;
(c) a particular attribute of a person, animal and/or object identified within the first and/or second surveillance zone; and
(d) a threshold time a person and/or object enters, leaves or remains within the first and/or second surveillance zone.

Typically, if the surveillance zone may include a person, animal and/or object, the at least one surveillance ranking parameter may include at least one of a particular size, shape, weight, movement, colour, temperature, smell, and sound of the person, animal or object under surveillance. It would be readily appreciated by a person skilled in the art that other suitable parameters of a person, animal and/or object may similarly be used depending upon the specific circumstances and context of the surveillance.

Preferably, the surveillance ranking parameter associated with each received input data when conducting comparisons, may be user-definable by programming the computerised system.

Typically, the at least one characteristic of the first and/or second surveillance zone includes identification and/or measurement of at least one of:

(a) a number of persons, animals and/or objects within the first and/or second surveillance zone;
(b) a position of a person, an animal, and/or an object within the first and/or second surveillance zone;
(c) a particular attribute of a person, animal and/or object within the first and/or second surveillance zone; and
(d) a time a person, animal and/or object enters, leaves or remains within the first and/or second surveillance zone.

Typically, if the surveillance zone includes a person, animal and/or object, the characteristic of the surveillance zone may include identification and/or measurement of at least one of a size, shape, weight, movement, colour, temperature, smell, and sound of the person, animal and/or object under surveillance. It would be readily appreciated by a person skilled in the art that other suitable parameters of a person, animal and/or object may similarly be used.

Typically, a plurality of characteristics of the first and/or second surveillance zones may be compared against a plurality of surveillance ranking parameters. Advantageously, by comparing multiple characteristics of a surveillance zone against multiple surveillance ranking parameters, this may in certain circumstances provide a more accurate and flexible indication of a potential security threat warranting priority surveillance.

Preferably, a priority rating value may be assigned to the result of each comparison between the characteristics and the at least one surveillance ranking parameter, whereby the ranking of first and second surveillance zones in order of priority for surveillance may be at least performed with reference to the assigned priority rating values. Advantageously, the assigned priority rating values may provide an indication and/or a quantifiable measure of the extent to which characteristics of a surveillance zone captured by an input device are considered to meet (or not meet) a surveillance ranking parameter. Accordingly, the priority rating values may conveniently be used to provide at least one basis for ranking the corresponding surveillance zones in order of their priority for surveillance. Furthermore, where input datas captured by input devices may have been archived, the priority rating values associated with the relevant archived input datas may be used as a basis for searching and retrieving only the most pertinent input datas (or specific time intervals of the archived input datas).

Preferably, the present invention includes a step of communicating information to a user (such as a security guard) identifying which of the first and second surveillance zones is of higher priority for surveillance based on the ranking of the first and second surveillance zones. Alternatively and/or additionally, the information communicated to the user may include identification of surveillance zones which meet and/or exceed a predetermined ranking threshold.

Typically, the information includes a text or graphic message. Alternatively, the information may include an audio message such as a pre-recorded telephone message or audible alarm. Typically, the information communicated to the user may include identification of a location of the surveillance zone ranked as being of relatively higher priority for surveillance and/or the identity of the input device(s) associated with that particular surveillance zone, or, identification of a location of at least one surveillance zone having a ranking which exceeds the predetermined ranking threshold. Also typically, the information may include a representation of real-time image or video data captured by a camera monitoring the surveillance zone ranked as being of relatively higher priority for surveillance.

Preferably, the computerised system includes a central server configured for ranking the first and second surveillance zones in order of priority for surveillance by reference to results of the comparisons of the characteristics with the at least one surveillance ranking parameter. Ranking may typically be performed in accordance with a ranking algorithm including reference to priority rating values.

Typically, the first and/or second input device may be directly and/or indirectly interfaced for communication with the computerised system via a wired and/or wireless communication link.

Typically, the first and/or second input datas representing characteristics of the first and second surveillance zones respectively may be recorded in a memory store. Preferably, the input data of a surveillance zone ranked of relatively higher priority may be automatically recorded. Typically the step of recording the input data may include associating time stamps of portions of the stored input data with corresponding priority rating values and/or ranking values calculated with reference to the specific time stamped portions of the input data to assist a user in selectably retrieving archived input data. Advantageously, this may provide ease of searching and retrieving only the most pertinent input datas (or specific time stamped portions of the archived input datas).

In a second broad form, the present invention provides a method of performing a surveillance of a plurality of surveillance zones operable using a computerised system communicably interfaced with a plurality of input devices, each of the plurality of surveillance zones being monitored by at least one of the plurality of input devices, the method including the steps of:
(i) the computerised system receiving input datas captured by each of the plurality of input devices, the received input datas representing characteristics of the surveillance zones under surveillance by the respective input devices;
(ii) the computerised system comparing at least one characteristic of each surveillance zone against at least one surveillance ranking parameter;
(iii) the computerised system assigning priority rating values to the results of each comparison between the at least one characteristic and the at least one surveillance ranking parameter;
(iv) the computerised system ranking the plurality of surveillance zones in order of priority for surveillance by reference to the priority rating values assigned to the results of each comparison; and
(v) displaying to a user, real-time image or video data captured by a camera monitoring a surveillance zone which has been ranked as being of relatively higher priority for surveillance than at least one other of the plurality of surveillance zone.

In a third broad form, the present invention provides a computerised system adapted for performing any one of the method steps in accordance with the first and/or second broad forms of the present invention.

In a fourth broad form, the present invention provides a computer-readable medium for storing an executable computer program adapted to perform the method steps in accordance with any one of the first and/or second broad forms of the present invention. Typically, the computer readable medium may include at least one of a CD, DVD, floppy disk, hard-disk drive, removable USB-drive or the like.

Advantageously, the present invention may assist in alleviating the need for human operators to manually review multiple camera feeds in order to identify potential security threats occurring in multiple surveillance zones. Accordingly, the risk of human error occurring when monitoring potential security threats may also be alleviated. Moreover, as the present invention is adapted for implementation using a computerised system, this may also alleviate costs incurred by manual review by human operators, and/or, the cost of purchasing additional display monitors (and storage space) typically required for review by human operators.

Also advantageously, the present invention may assist in providing a surveillance of all surveillance zones instead of merely focusing attention upon only a selection of surveillance zones assumed to be of “high risk”. Accordingly, this may also alleviate the risk of security threats captured by certain cameras being overlooked.

The present invention provides yet a further advantage in that by allowing monitoring of all surveillance zones in real-time, this may alleviate the time and costs associated with archiving data captured by certain “low priority” cameras for later review. Nevertheless, where archiving is still desired, captured input datas relating to surveillance zones may be archived by associating specific time stamped portions of the captured input datas with corresponding priority rating values and/or surveillance ranking values calculated with reference to the specific time stamped portions of the captured input datas in seeking to provide ease of searching and/or retrieval of the most pertinent input data.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows a flowchart of method steps in accordance with a first embodiment of the present invention; and

FIG. 2 shows a block diagram of a computerised system consisting of six functional modules for performing the first embodiment method.

### MODES FOR CARRYING OUT THE INVENTION

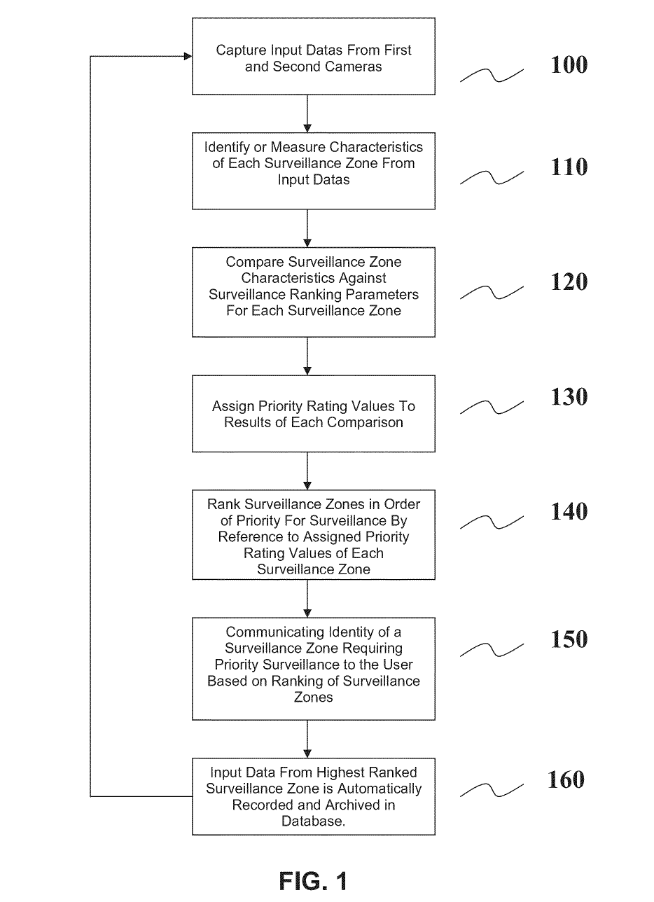

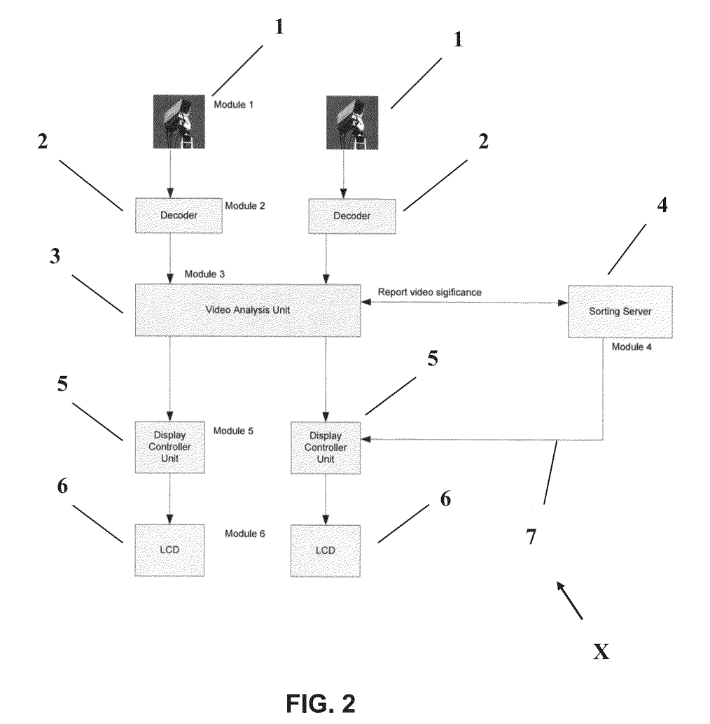

Preferred embodiments of the present invention will now be described herein with reference to FIGS. 1 and 2. FIG. 1 shows a flowchart of method steps in accordance with a first embodiment of the present invention whilst FIG. 2 shows a block diagram of a computerised system (X) consisting of six functional modules for performing the first embodiment method. Each of the functional modules includes a computer processor, memory store and input and output ports via which data is received or transmitted. The six functional modules are communicably connected via any suitable wired or wireless communication link (7).

It would be understood by a person skilled in the art that whilst the preferred embodiments described herein refer to six functional modules, this is for illustrative purposes only. In certain embodiments of the present invention, the six functional modules described herein may be functionally and/or physically merged in varying combinations and configurations.

The embodiments to be described herein are configured to perform a surveillance of multiple physically-separated surveillance zones simultaneously, and, to provide a user with real-time updates indicating which surveillance zone(s) are of a relatively higher priority for surveillance based upon a priority ranking assigned to the surveillance zones. In describing the preferred embodiments, the term “surveillance zone” typically refers to a three-dimensional space or region of interest such as a room or thoroughfare. However, the term “zone” could also refer to a sub-region of another “zone” for instance in a situation where two cameras are monitoring different aspects of the same room. Furthermore, a “zone” would also be understood to include a person, animal and/or an object (e.g. a suitcase, package, or vehicle).

For the purposes of illustrating functioning of the preferred embodiment, a first module (1) is provided consisting of two analogue video cameras which capture video data representing visual characteristics of two separate surveillance zones (e.g. two different rooms in a building) under surveillance. In other embodiments, more than two cameras or other types of input devices could of course be used to monitor characteristics of different surveillance zones. Alternatively, in certain embodiments one surveillance zone may be monitored by a camera whilst another surveillance zone may be monitored by a different type of sensing device such as an infra-red sensor, a radiation detector, a sound sensor, a temperature sensor, an air-quality sensor, a pressure sensor, or any combination thereof. By employing different combinations of input devices to monitor more diverse characteristics of each surveillance zone, this may conceivably provide a more flexible and accurate identification of possible security threats such as the presence of suspicious persons or objects (e.g. indicative of criminal or terrorist activity), fire hazards, medical emergencies and so on.

The analogue video datas are captured in real-time by the cameras and are converted into digital video signals using an analogue-to-digital converter suitable for transmission via TCP/IP protocol to other functional modules in the computerised system for processing. In the preferred embodiments, the digital video signals are also compressed before transmission using either the MPEG4 or H.264 format. This step is represented by block (100) in FIG. 1. In alternative embodiments of the present invention, the first module (1) may include use of Internet-Protocol cameras to directly output video data streams in for instance MPEG4 or H.264 format. In yet alternative embodiments, it may not be necessary or considered desirable to encode the output signals of the cameras for instance due to cost constraints.

The digital video data signals from each camera are transmitted to a second module (2) which in the preferred embodiments includes a hardware-based signal decoder for decoding the incoming signals. Accordingly, incoming signals in either analogue, MPEG4, H.264 or any other suitable format are decoded into raw (uncompressed) video data format.

A third module (3) is provided consisting of a video analysis unit which receives and processes uncompressed video data decoded by the second module (2) in accordance with a video analysis algorithm. The video analysis unit could be implemented as software for running on a computing device, or, as hardware in the form of a digital signal processor, a field-programmable gate array or an integrated circuit. In the preferred embodiments, the video analysis unit is implemented using an integrated circuit which is configured to identify and compare certain characteristics of each surveillance zone represented by the uncompressed video data against several surveillance ranking parameters applicable and relevant to each of the surveillance zones. It would be appreciated by a person skilled in the art that the video analysis unit could utilise a suitable signal processing algorithm for performing video analysis of incoming digital video data signals (e.g. encoded in MPEG4 or H.264 format) received directly from the first module (1) cameras. That is, a signal processing algorithm could be utilised by the video analysis unit to perform video analysis of incoming video data signals received directly from the first module without needing to first be pre-converted into a raw data format by the second module (2). Accordingly, in certain embodiments, the video analysis unit could be configured to directly process compressed incoming video data.

The surveillance ranking parameters of each surveillance zone are user-definable by programming the third module (3) via an interface consisting of a menu of selectable commonly used surveillance ranking parameter options. As it will typically be the case that a camera will be assigned to uniquely monitor one corresponding surveillance zone, the relevant surveillance ranking parameters to be applied to the surveillance zone will be automatically referenced and applied whenever the third module (3) detects incoming raw video data received from the corresponding camera monitoring the surveillance zone.

By way of example, in the preferred embodiments, the surveillance ranking parameters applicable to each surveillance zone includes at least one of a threshold number of persons, animals and/or objects identified and/or measured within a surveillance zone, a particular attribute of a person, animal and/or object identified within a surveillance zone, a threshold position of a person, animal and/or object (e.g. such as an unattended suitcase indicative of a potential bomb threat) within a surveillance zone, and, a threshold time at which a person, animal and/or an object has entered, exited or remained within the surveillance zone.

The surveillance ranking parameters associated with each surveillance zone may vary as they may not all be relevant or applicable to all surveillance zones at any given time. For instance, where one surveillance zone includes a relatively small room patrolled by security guards it may not be of high priority for the surveillance system to identify suspicious looking persons or objects within the room given the likelihood that the security guards may readily notice and deal with such persons or objects without requiring additional assistance. However, in another surveillance zone, such as a large openly accessible car park with no patrolling security guards, it may be highly desirable for embodiments of the surveillance system to assist in identifying any suspicious persons (e.g. indicative of potential car thieves) or objects within the car park.

In order to determine if the surveillance ranking parameters associated with a given surveillance zone are met and/or the extent to which they are met (or otherwise), relevant characteristics of each surveillance zone are identified or measured by the third module (3) by analysing the received raw video signals representing each surveillance zone under surveillance. The third module is automatically configured to identify and/or measure specific characteristics of a surveillance zone in response to the particular choice of ranking parameters associated with the surveillance zone. This step is represented by block (110) in FIG. 1.

Characteristics identified or measured by the third module (3) include an indication of the number of people, animals and/or objects identified within a surveillance zone at any given time, the location of a person, animal and/or object within a surveillance zone, the relative proximity of a person, animal or object within the surveillance zone, the attributes of persons, animals and/or objects identified within a surveillance zone, and/or the time a person, animal and/or object enters, leaves or remains within a surveillance zone. Alternatively, the identified or measured characteristics could include identification and/or measurement of specific attributes of a person, animal and/or object.

In this embodiment any number of suitable image, video or multimedia processing techniques known to a person skilled in the art may be employed by the third module (3) to identify or measure relevant characteristics within the surveillance zones. In other embodiments where non-camera input devices are employed, suitable alternative processing techniques and algorithms may be used to analyse the captured data for extracting relevant characteristics of a surveillance zone. For instance, where the input device is an infra-red sensor, the number and location of persons within a surveillance zone of interest at any given time could be determined by analysis of reflection or breakage of infra-red beams projecting into the surveillance zone as would be readily known and understood by a person skilled in the art.

Once the relevant characteristics of each surveillance zone under surveillance are identified or measured by the third module (3), the characteristics are compared against the relevant surveillance ranking parameters applicable to each surveillance zone. This step is represented by block (120) in FIG. 1.

In response to each comparison which is performed between characteristics and surveillance ranking parameters for each surveillance zone, at least one priority rating value is assigned to the comparison based upon a predetermined assignment scheme. This step is represented by block (130) in FIG. 1.

By way of example only, if the characteristic of the surveillance zone indicates that only two persons are identified within the surveillance zone and the surveillance ranking parameter requires that three persons be identified in the surveillance zone in order for a security threat to be perceived, a priority rating value of “0” may be assigned to the result of the comparison reflecting a relatively low security-threat since the surveillance ranking parameter has not been met. Conversely, if the characteristic of the surveillance zone indicates that 5 persons are within the surveillance zone, then the surveillance ranking parameter would be exceeded and a priority rating value of “1” may for instance be assigned to the result of the comparison reflecting a relatively high security threat. Alternatively, a “non-binary” assignment scheme could be adopted such as assigning a value between 1-100 in response to each comparison not only as an indication as to whether a surveillance ranking parameter has been exceeded or not, but also, the extent to which the parameter has been exceeded or not exceeded.

Furthermore, the priority rating value may also be assigned to a comparison by reference to the specific nature or type of security threat detected within any given surveillance zone by the third module (3). The nature or type of security threat is determined by reference to the identified and/or measured characteristics in a given surveillance zone. For instance, detection of a fire may be assigned a relatively higher priority rating value compared to certain other detected events.

It would be appreciated that regardless of the particular assignment scheme adopted, the value of the priority rating value assigned to each comparison provides a quantitative indication of the perceived security threat associated with any given surveillance zone based upon the comparison of the surveillance zone characteristics with the predefined surveillance ranking parameters for that surveillance zone. Consequently, different surveillance zones can then be ranked in order of perceived security threat by reference to the assigned priority rating values so as to conveniently provide a user with an indication as to which particular surveillance zone(s) are of relatively higher priority for surveillance at any given time.

As several comparisons will be conducted between multiple surveillance ranking parameters and multiple identified/measured surveillance zone characteristics for each surveillance zone in the preferred embodiments, the priority rating values assigned to the results of the comparisons for a given surveillance zone could be simply added together to provide a cumulative priority rating value. Alternatively, priority rating values assigned to the comparison results for each surveillance zone could be variably weighted according to a predetermined weighting scheme based on a user's perception and predetermination of the degree of relevance and/or importance of each comparison in indicating an overall security threat.

Once priority rating values for each surveillance zone have been calculated by the third module (3), these priority rating values are communicated to a fourth module (4). The fourth module (4) in the preferred embodiments includes a centralised computer server which is programmed to sort or rank the surveillance zones in order of priority for surveillance. This step is represented by block (140) in FIG. 1. This step may simply involve ranking the surveillance zones in order of priority based directly upon the magnitude of the priority rating values associated with the surveillance zones.

More complex ranking algorithms may also be used which may for instance not only take into account the assigned priority rating values but also the specific nature or type of security threat(s) captured by cameras monitoring the surveillance zones. For instance, if a security threat captured by a camera indicates that a fire is taking place then a predetermined weighting value associated with the security threat could be additionally and/or alternatively taken into account by the ranking algorithm when ranking the surveillance zones in order of priority.

In the preferred embodiments, the process of ranking surveillance zones in order of priority for surveillance is conducted at regular intervals of approximately 5 seconds. The intervals could of course be varied by a user if so required by programming the computerised system. Every time the surveillance zones are ranked, information identifying the surveillance zone determined to be of highest priority for surveillance is automatically communicated to a fifth module (5) which comprises a display controller unit. This step is represented by block (150) in FIG. 1.

The display controller unit is configured to selectably transmit information relating to the surveillance zone of highest priority to a sixth module (6) which in this embodiment comprises either an LCD display terminal located in a central monitoring station, or, a mobile communication device such as a mobile phone, PDA or pager. Conveniently, the information in the form of an SMS, email or pager message could be conveniently and rapidly communicated to a security guard in the vicinity of the surveillance zone identified by the preferred embodiments as requiring relatively higher priority surveillance.

In this embodiment, a live video or image feed from a camera monitoring the highest priority ranked surveillance zone is also automatically transmitted to the sixth module (6) for display to a user. Additionally, information identifying the location of the surveillance zone and the camera capturing images of the surveillance zone are also automatically communicated to the LCD display terminal or mobile communication device to alert the user of which surveillance zone(s) are ranked higher for priority surveillance. The user may then be in better position to attend a priority surveillance zone or dispatch other parties to attend a priority surveillance zone.

The display controller unit is responsible for properly formatting and configuring the video or image data feed from the relevant camera so that it is able to be properly rendered on to the desired LCD display or mobile communication device.

In the preferred embodiments, video and/or image data captured by at least some of the cameras are recorded and archived in a database for later retrieval and display. Specifically, the video and/or image data representing characteristics of highly-ranked surveillance zones are automatically recorded and archived which is convenient in circumstances where such data may constitute evidentiary material. During the step of archiving, time stamps of the captured video and/or image data are associated with corresponding priority rating values and/or ranking values which have been calculated with reference to the relevant time stamped video and/or image data. This conveniently assists in allowing a user to selectably retrieve archived data relating to only the most important video or image feeds. Recordal and archiving of data in this manner may continue for a predetermined time period of for instance, 2-3 hours, or, may be manually deactivated depending upon user-programmable settings. The step of automatically recording and archiving video and/or image data is represented by block (160) in FIG. 1.

In certain embodiments of the present invention, surveillance zones are categorised into different groups depending upon whether the rankings of the surveillance zones meet one or more predetermined thresholds. By way of example, the top 10 percent ranked surveillance zones may constitute a first group, the next 30 percent ranked surveillance zones may constitute a second group and the remaining 60 percent ranked surveillance zones may constitute a third group. Alternatively and/or additionally, the thresholds which are used to categorise the surveillance zones into different groups may be based not only upon ranking but also upon the nature of a security risk event or other event of interest which are detected within the surveillance zones. Information communicated to a user in respect of one or more surveillance zones may include a distinctive visual and/or audio alert indicative of the category in which the particular surveillance zones have been assigned. For instance, different coloured boxes may be flashed around live video/image data displayed to the user indicative of the category of the surveillance zone represented by the video/image data.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A method of performing a surveillance of at least a first and a second surveillance zone, the method being operable using a computerised system and comprising the steps of:
(i) receiving first and second input datas representing characteristics of the first and second surveillance zones respectively;
(ii) comparing the characteristics of the first and second surveillance zones against at least one surveillance ranking parameter; and
(iii) ranking the first and second surveillance zones in order of priority for surveillance by reference to results of the comparisons of the characteristics with the at least one surveillance ranking parameter.

2. A method as claimed in claim 1 wherein the first and second input datas are captured by separate input devices.

3. (canceled)

4. A method as claimed in claim 2 wherein if the input data comprises image or video data captured by a camera, characteristics of the first and/or second surveillance zone represented by the image or video data are identified and/or measured using a computerised image processing technique.

5. A method as claimed in claim 1 wherein the first and/or second surveillance zones comprise at least one of a two-dimensional space, a three-dimensional space, a person, an animal and an object.

6. A method as claimed in claim 4 wherein if the surveillance zone comprises a three-dimensional space, the at least one surveillance ranking parameter comprises at least one of:
(a) a threshold number of persons, animals and/or objects identified or measured in the first and/or second surveillance zone;
(b) a threshold position of a person, animal, and/or object within the first and/or second surveillance zone;
(c) a particular attribute of a person, animal and/or object identified within the first and/or second surveillance zone; and
(d) a threshold time a person and/or object enters, leaves or remains within the first and/or second surveillance zone.

7. A method as claimed in claim 4 wherein if the surveillance zone comprises a person, animal or object, the at least one surveillance ranking parameter comprises at least one of a particular size, shape, weight, movement, colour, temperature, smell, and sound of the person, animal or object under surveillance.

8. A method as claimed in claim 1 wherein the surveillance ranking parameter associated with each received input data when conducting comparisons is user-definable by programming the computerised system.

9. A method as claimed in claim 8 wherein the at least one characteristic of the first and/or second surveillance zone comprises identification and/or measurement of at least one of:
(a) a number of persons, animals and/or objects within the first and/or second surveillance zone;
(b) a position of a person, an animal, and/or an object within the first and/or second surveillance zone;
(c) a particular attribute of a person, animal and/or object within the first and/or second surveillance zone; and
(d) a time a person, animal and/or object enters, leaves or remains within the first and/or second surveillance zone.

10. (canceled)

11. A method as claimed in claim 1 wherein a plurality of characteristics of the first and/or second surveillance zones are compared against a plurality of surveillance ranking parameters.

12. A method as claimed in claim 1 wherein a priority rating value is assigned to the result of each comparison between the characteristics and the at least one surveillance ranking parameter, whereby the ranking of first and second surveillance zones in order of priority for surveillance is performed with reference to the assigned priority rating values.

13. A method as claimed in claim 1 comprising the step of communicating information to a user identifying which of the first and second surveillance zones is of higher priority for surveillance based on the ranking of the first and second surveillance zones, and/or, communicating information to the user identifying whether either of the first and second surveillance zones meets and/or exceeds a predetermined threshold ranking threshold.

14. (canceled)

15. A method as claimed in claim 13 wherein the information communicated to the user comprises identification of a location of the surveillance zone ranked as being of relatively higher priority for surveillance and/or an identity of the input device assigned to capture input data representing characteristics of the surveillance zone.

16. A method as claimed in claim 13 wherein the information comprises a representation of real-time image or video data captured by a camera associated with the surveillance zone ranked as being of relatively higher priority for surveillance.

17. A method as claimed in claim 1 wherein the computerised system comprises a central server configured for ranking the first and second surveillance zones in order of priority for surveillance by reference to results of the comparisons of the characteristics with the at least one surveillance ranking parameter.

18. (canceled)

19. A method as claimed in claim 1 wherein at least one of the first and second input datas are recorded.

20. A method as claimed in claim 19 wherein the first or second input datas are selectably recorded depending upon which one is ranked relatively higher in priority for surveillance.

21. A method as claimed in claim 19 wherein when recorded time stamps of archived first and/or second input datas are associated with priority rating values and/or ranking values which have been calculated with reference to the corresponding time stamped portions of the first and/or second input datas whereby selectable searching and/or retrieval of specific time stamped portions of the stored first and/or second input datas is enabled by reference to associated priority rating values and/or ranking values.

22. A method of performing a surveillance of a plurality of surveillance zones operable using a computerised system communicably interfaced with a plurality of input devices, each of the plurality of surveillance zones being monitored by at least one of the plurality of input devices, the method comprising the steps of:
(i) the computerised system receiving input datas captured by each of the plurality of input devices, the received input datas representing characteristics of the surveillance zones under surveillance by the respective input devices;
(ii) the computerised system comparing at least one characteristic of each surveillance zone against at least one surveillance ranking parameter;
(iii) the computerised system assigning priority rating values to the results of each comparison between the at least one characteristic and the at least one surveillance ranking parameter;
(iv) the computerised system ranking the plurality of surveillance zones in order of priority for surveillance by reference to the priority rating values assigned to the results of each comparison; and
(v) displaying to a user, real-time image or video data captured by a camera monitoring a surveillance zone which has been ranked as being of relatively higher priority for surveillance than at least one other of the plurality of surveillance zone.

23. A computerised system adapted for performing the method steps in accordance with claim 1.

24. A computerised system adapted for performing the method steps in accordance with claim 1.

25. (canceled)
